(19) United States
(12) Patent Application Publication
(10) Pub. No.: US 2021/0323581 A1
(43) Pub. Date: Oct. 21, 2021

(54) MOBILE ARTIFICIAL INTELLIGENCE ROBOT AND METHOD OF CONTROLLING THE SAME

(71) Applicant: LG ELECTRONICS INC., Seoul (KR)

(72) Inventors: Jeongwoo JU, Seoul (KR); Wonhee LEE, Seoul (KR)

(21) Appl. No.: 16/490,460

(22) PCT Filed: Jun. 17, 2019
(86) PCT No.: PCT/KR2019/007268

§ 371 Date: Aug. 30, 2019

(51) Int. Cl. B60W 60/00; G05D 1/12; B62D 33/02; B62D 33/08

(52) U.S. Cl. CPC B60W 60/00256; G05D 1/12; B62D 33/02; G10L 15/22; B60W 2540/21; B60W 2420/42; B62D 33/08

(57) ABSTRACT

Disclosed is a mobile robot including a body forming an outer appearance, a driving part configured to move the body, an image acquisition unit configured to capture an image of a traveling area and to generate image information, a tray configured to support an article to be carried, and a controller configured to determine a size of the article to be carried and to form an inclined surface by controlling a slide module disposed above the tray to move at least one slide of the slide module to protrude depending on the size of the article to be carried. Accordingly, a porter robot loads a load in an accommodation space without lifting the load by a user.

### TECHNICAL FIELD

The present invention relates to a mobile robot and a method of controlling the same for stably carrying a load according to the size of the load when a mobile artificial intelligence robot for carrying the load travels.

### BACKGROUND ART

Robots have been developed for industrial use to manage some parts of factory automation. Recently, the application fields of robots have further expanded, leading to the development of medical robots, aerospace robots, etc. and the manufacture of robots used in general homes for domestic uses. Among such robots, an autonomous mobile robot is referred to as a mobile robot.

With the increase in the use of robots, the demand for robots capable of providing various kinds of information, entertainment, and services in addition to the repeated performance of simple functions has increased.

Accordingly, various kinds of robots for use in a home, restaurants, stores, and public facilities so as to provide convenience to people are being developed.

In addition, various kinds of services using a mobile robot that is capable of autonomously traveling have been proposed. For example, the cited reference (Korean Patent Application Publication No. 10-2008-0090150, Published on Oct. 8, 2008) proposes a service robot capable of providing a service based on a current position thereof while moving in a service area, a service system using the service robot, and a method of controlling the service system using the service robot.

However, a porter robot that is currently published has difficulty in lifting and moving a load to an accommodation space disposed in a traveling unit.

In particular, when the old and the infirm or women have large baggage in an airport, a hotel, or the like, in which a porter robot is used, they have difficulty in using the porter robot because they are not capable of lifting the load to the accommodation space of the corresponding porter robot.

### CITED REFERENCE

### Patent Document

(Patent Document 1) Korean Patent Publication No. 10-2008-0090150 (Published on Oct. 8, 2008)

### DISCLOSURE

### Technical Problem

It is a first object of the present invention to provide a porter robot for loading a load, which is to be carried by a user, in an accommodation space without lifting the load.

It is a second object of the present invention to provide a porter robot for loading a load, which is to be carried, in an accommodation space irrespective of the size of the load by tilting a slide and adjusting the length of the slide depending on the size of the load.

### Technical Solution

In accordance with the present invention, the above and other objects can be accomplished by the provision of a method of controlling a mobile robot, the method including receiving user input including a predetermined service request by the mobile robot, determining a size of an article to be carried, by the mobile robot, and forming an inclined surface by controlling a slide module disposed above a tray to move at least one slide of the slide module to protrude depending on the size of the article to be carried.

The mobile robot may be configured in such a way that the tray is defined as a plat surface that accommodates the article to be carried and that the slide module is disposed above the tray and includes the at least one slide moved to protrude in a direction parallel to the tray.

The forming the inclined surface may include disposing the slide module above the tray and moving the at least one slide to protrude in the direction parallel to the tray.

The forming the inclined surface may include forming the inclined surface by controlling a motor of the slide module to tilt the at least one slide that protrudes.

When a size of the article to be carried is equal to or greater than a predetermined size, the inclined surface may be formed by moving a first slide to protrude and then moving a second slide disposed above the first slide to protrude from the first slide.

Movement of the second slide may be controlled to satisfy a condition in which the sum of a length of the first slide and a length that the second slide protrudes is greater than a width of the article to be carried.

The determining the size of the article to be carried may include acquiring an image from an image acquisition unit and extracting a size of the article to be carried by learning an object.

The receiving the user input may include asking about whether the article is carried, receiving a response of the user in response to the asking, and analyzing whether a user request is present, from the response of the user.

The method may further include searching for the user at a short distance, following the retrieved user, and acquiring an image of the user, by the mobile robot.

In accordance with another aspect of the present invention, there is provided a mobile robot including a body forming an outer appearance, a driving unit configured to move the body, an image acquisition unit configured to capture an image of a traveling area and to generate image information, a tray configured to support an article to be carried, and a control unit configured to determine a size of the article to be carried and to form an inclined surface by controlling a slide module disposed above the tray to move at least one slide of the slide module to protrude depending on the size of the article to be carried.

The mobile robot may be configured in such a way that the slide module is disposed above the tray and includes the at least one slide moved to protrude in a direction parallel to the tray.

The slide module may be disposed above the tray and moves the at least one slide to protrude in the direction parallel to the tray.

The inclined surface may be formed by controlling a motor of the slide module to tilt the at least one slide that protrudes.

When a size of the article to be carried is equal to or greater than a predetermined size, the inclined surface may be formed by moving a first slide to protrude and then moving a second slide disposed above the first slide to protrude from the first slide.

Movement of the second slide may be controlled to satisfy a condition in which the sum of a length of the first slide and a length that the second slide protrudes is greater than a width of the article to be carried.

The control unit may acquire an image from the image acquisition unit and may extract a size of the article to be carried by learning an object.

The control unit may ask about whether the article is carried and may analyze whether a user request is present, from the response of the user to the asking.

The mobile robot may search for the user at a short distance, follows the retrieved user, and may acquire an image of the user.

The mobile robot may transmit information indicating that carrying is terminated, to a server, and may return to a start point.

### Advantageous Effects

According to the above technical solution, the present invention may provide a porter robot for loading a load, which is to be carried by a user, in an accommodation space without lifting the load.

In addition, the porter robot may load a load, which is to be carried, in an accommodation space irrespective of the size of the load by tilting a slide and adjusting the length of the slide depending on the size of the load.

### DESCRIPTION OF DRAWINGS

FIG. 1 is a diagram showing a configuration of a mobile robot system according to an embodiment of the present invention.

FIG. 2 is a perspective view of the mobile robot of FIG. 1 viewed in a first direction.

FIG. 3 is a perspective view of the mobile robot of FIG. 1 viewed in a second direction.

FIG. 4 is a block diagram showing a control relationship in the mobile robot of FIG. 1.

FIG. 5 is a flowchart showing a loading method of the mobile robot of FIG. 1.

FIG. 6 is a diagram showing a state based on the loading method of FIG. 5.

FIG. 7 is a flowchart showing an example of a loading method of the mobile robot of FIG. 5.

FIGS. 8 to 10 are diagrams showing a state of a mobile robot based on the flowchart of FIG. 7.

### BEST MODE

Terms indicating directions, such as “front (F)/rear (R)/left (Le)/right (Ri)/up (U)/down (D)” used below are defined based on the accompanying drawings, but they are used only to promote a clear understanding of the present invention, and the definition of directions is changed according to a reference.

Terms such as “first” and “second” are used herein merely for the purpose of distinguishing one constituent element from another constituent element, and do not define the order, importance, or master-servant relationship of components. For example, it may be possible to embody the invention so as to include only the second component without the first component.

Components in the following drawings may be exaggerated, omitted, or schematically illustrated for convenience and clarity of explanation. The sizes and areas of the components do not accurately reflect their actual sizes.

In addition, angles and directions used in description of the configuration of the present invention are based on the accompanying drawings. If a reference or a positional relationship between angles is not clearly set forth in the description of the configuration in the specification, the related drawings are to be referred to.

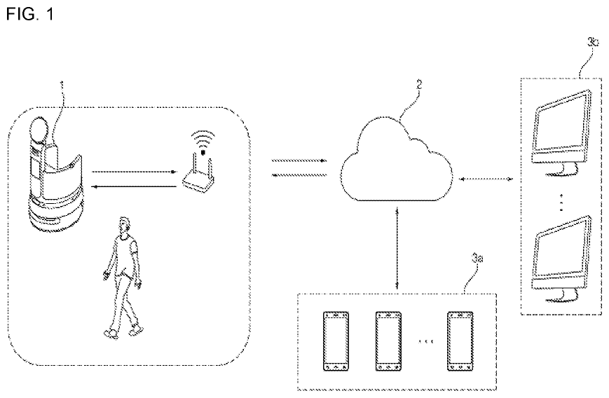

Hereinafter, a porter robot, among mobile robots, will be exemplified with reference to FIGS. 1 to 5, but the present invention does not need to be limited thereto.

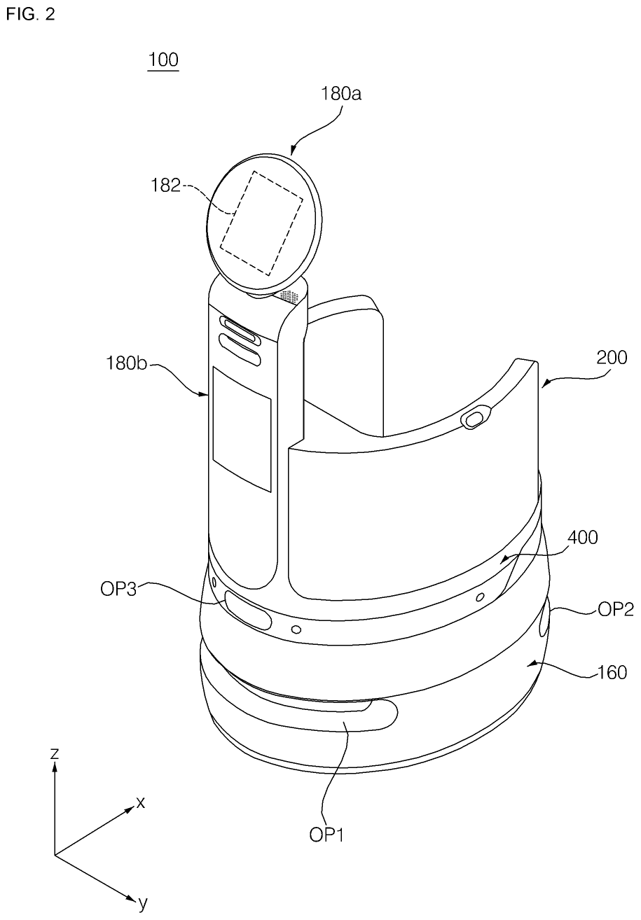

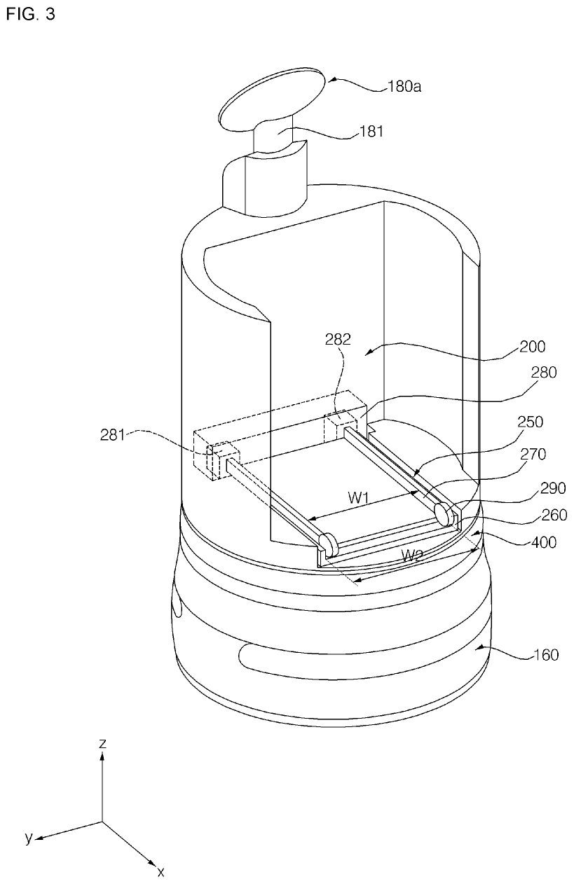

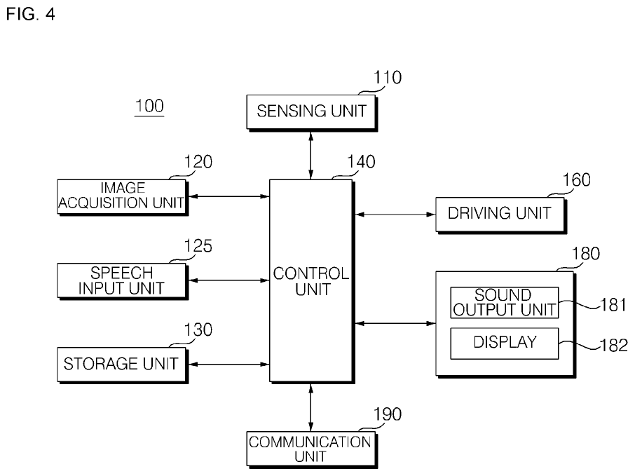

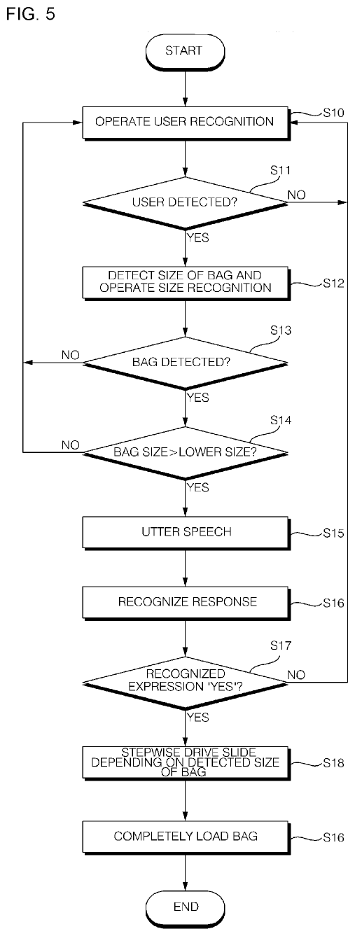

FIG. 1 is a diagram showing a configuration of a mobile robot system according to an embodiment of the present invention. FIG. 2 is a perspective view of the mobile robot of FIG. 1 viewed in a first direction. FIG. 3 is a perspective view of the mobile robot of FIG. 1 viewed in a second direction. FIG. 4 is a block diagram showing a control relationship in the mobile robot of FIG. 1. FIG. 5 is a flowchart showing a loading method of the mobile robot of FIG. 1.

Referring to FIG. 1, the robot system according to an embodiment of the present invention may include one or more robots 100 and may provide a service in various places such as a restaurant, a home, a hotel, a market, a clothing store, a warehouse, and a hospital. For example, the robot system may include a porter robot 100 that interacts with a user in a home or the like and carries a predetermined article to a position desired by a user based on user input.

The robot system according to an embodiment of the present invention may include the plurality of porter robots 100 and a server 2 configured to manage and control the plurality of porter robots 100.

The server 2 may remotely monitor and control states of the plurality of robots 100, and the robot system may provide a more effective service using the plurality of robots 100.

The plurality of robots 100 and the server 2 may include a communication device for supporting one or more communication standards, and may communicate with each other. The plurality of robots 100 and the server 2 may communicate with a personal computer (PC), a mobile terminal, or another external server.

For example, the plurality of robots 100 and the server 2 may be embodied to perform wireless communication using wireless communication technology such as IEEE 802.11 WLAN, IEEE 802.15 WPAN, UWB, Wi-Fi, ZigBee, Z-wave, Bluetooth, or the like. The robot 100 may be changed depending on a communication method of other communication target devices or the server 2.

In particular, the plurality of robots 100 may embody wireless communication with other robot 100 and/or the server 2 through a 5G network. When the robot 100 performs wireless communication through a 5G network, real-time response and real-time control may be possible.

The plurality of robots 100 and the server 2 may communicate with each other using a message queuing telemetry transport (MQTT) method or a hypertext transfer protocol (HTTP) method.

The plurality of robots 100 and the server 2 may communicate with a PC, a mobile terminal, or other external servers using the HTTP or MQTT method.

Depending on the cases, the plurality of robots 100 and the server 2 may support two or more communication standards and may use the optimum communication standard depending on the type of communication data, or the type of device that participates in communication.

A user may check or control information on the robots 100 in the robot system through a PC 3a, a mobile terminal 3b, or the like.

In the specification, the ‘user’ may be a person who uses a service through at least one robot, and may include an individual consumer who purchases or rents a robot and uses the robot in a home or elsewhere, managers and employees of a company that provides a service to an employee or a consumer using a robot, and consumers that use a service provided by such a company. Thus, the ‘user’ may include business-to-consumer (B2C) and business-to-business (B2B) cases.

The server 2 may be embodied as a cloud server, and the user may use data stored in the server 2, which is connected for communication to various devices such as the PC 3a, the mobile terminal 3b, or the like and a function and a service that are provided by the server 2. The cloud server 2 may interwork with the robot 100, may monitor and control the robot 100, and may remotely provide various solutions and contents.

The server 2 may collectively control the robots 100 in the same way, or may separately control the robots. The server 2 may organize at least some of the robots 100 into groups, and may control the groups individually.

The server 2 may include a plurality of servers in which information and functions are distributed and configured or may be configured with one integrated server.

The robot 100 and the server 2 may each include a communication device (not shown) for supporting one or more communication standards, and may communicate with each other.

The robot 100 may transmit data related to space, an object, or usage thereof to the server 2.

Here, the data related to space or an object may be recognition relevant data of space or an object that is recognized by the robot 100 or may be image data of space or an object, which is acquired by an image acquisition unit.

In some embodiments, the robot 100 and the server 2 may include artificial neural networks (ANN) in the form of software or hardware that is trained to recognize at least one of the attributes of a user, speech, or space, or the attributes of an object such as an obstacle.

According to an embodiment of the present invention, the robot 100 and the server 2 may include a deep neural network (DNN) such as a convolutional neural network (CNN), a recurrent neural network (RNN), or a deep belief network (DBN), which is trained through deep learning. For example, a deep neural network (DNN) such as a convolutional neural network (CNN) may be installed in a control unit 140 of the robot 100.

The server 2 may train a deep neural network (DNN) based on data received from the robot 100, data input by the user, or the like, and may then transmit updated deep neural network (DNN) data to the robot 100. Accordingly, the deep neural network (DNN), which embodies artificial intelligence in the robot 100, may be updated.

The data related to usage may be data acquired along with use of a predetermined good, e.g., the robot 100 and may correspond to usage history data, a detection signal acquired from a sensor unit 110, or the like.

The trained deep neural network (DNN) may receive input data for recognition, may recognize the attributes of a person, an object, and space included in which input data, and may output the result.

The trained deep neural network (DNN) may receive the input data for recognition, may analyze and learn the data related to usage of the robot 100, and may recognize a usage pattern, a usage environment, or the like.

The data related to space, an object, or usage may be transmitted to the server 2 through a communication unit 190.

The server 2 may train the deep neural network (DNN) based on the received data and may then transmit the updated deep neural network (DNN) data to the mobile robot 100 to update the same.

Accordingly, the robot 100 may become smarter and may provide a user experience (UX) in which the robot 100 evolves the more the user uses it.

The robot 100 and the server 2 may also use external information. For example, the server 2 may provide an excellent user experience (UX) by synthetically using external information acquired from other associated service servers (not shown).

According to the present invention, the robot 100 may output speech for actively providing information beforehand or recommending a function or a service to provide more various and active control function to the user.

FIGS. 2 to 5 illustrate an example of the porter robot 100 for carrying loads, e.g., a bag of a user.

Referring to the drawings, the porter robot 100 may move through autonomous traveling or following and may further include a tray for accommodating articles or loads to be loaded. For example, an article for a porter in a hotel may correspond to a large-volume load such as a bag of a guest staying in the hotel. In addition, an article for a porter in an airport may correspond to large-volume loads such as a travel bag containing articles required for travel.

The porter robot 100 may deliver a load to be carried to a destination determined by the user during autonomous traveling in a predetermined place and may unload the corresponding load at the destination.

A modular design may be applied to the porter robot 100 in order to provide an optimized service according to usage environments and uses.

For example, a basic platform may include a traveling module 160 including a wheel, a motor, or the like and being in charge of traveling, a UI module 180 including a display, a microphone, a speaker, or the like and being in charge of an interaction with the user, and a service module 200 providing a service such as storage of an article as a target of a porter.

Referring to the drawings, the traveling module 160 may include one or more openings OP1, OP2, and OP3.

The openings OP1, OP2, and OP3 may be formed by cutting the traveling module 160 such that front light detection and ranging (LiDAR) (not shown) therein is operable, and may extend from the front to the side of the outer circumferential surface of the traveling module 160.

The front LiDAR may be disposed in the traveling module 160 so as to face the opening OP1. Consequently, the front LiDAR may emit a laser through the opening OP1.

The other opening OP2, which is formed by cutting the traveling module 160 such that a rear LiDAR (not shown) therein is operable, may extend from the rear to the side of the outer circumferential surface of the traveling module 160, and may be formed such that the rear LiDAR therein is operable.

The rear LiDAR may be disposed to face the other opening OP2 in the traveling module 160. Accordingly, the rear LiDAR may emit a laser through the other opening OP3.

The other opening OP3 may be formed by cutting the traveling module 160 such that a sensor disposed in the traveling module, such as a cliff sensor for sensing whether a cliff is present on a floor within a traveling area, is operable.

A sensor may be disposed on the outer surface of the traveling module 160. An obstacle sensor, such as an ultrasonic sensor, for sensing an obstacle may be disposed on the outer surface of the traveling module 160.

For example, the ultrasonic sensor may be a sensor for measuring the distance between an obstacle and each of the porter robots 100. The ultrasonic sensor may sense an obstacle that is near the porter robot 100.

In some embodiments, at least a portion of the UI module 180 may be configured so as to be rotatable. For example, the UI module 180 may include a head unit 180a rotatable in left and right directions and a body unit 180b for supporting the head unit 180a. The UI module 180 may include a neck unit 181 configured to support the head unit 180a and disposed between the head unit 180a and the body unit 180b.

The head unit 180a may be rotated based on the operation mode and the current state of the porter robot 100.

The UI module 180 may further include a camera of an image acquisition unit 120. The camera may be disposed at the head unit 180a and may acquire image data in a predetermined range in the direction in which the head 180a is oriented.

For example, when the porter robot 100 detects a user, the head unit 180a may be rotated so as to orient the camera towards the identified user.

In some embodiments, the UI module 180 may include two displays 182a and 182b, and at least one of the two displays 182a and 182b may be configured with a touchscreen, and may also be used as an input device.

A service module 10 of the porter robot 100 may include at least one tray 400.

The service module 200 may be disposed above the traveling module 160 in upward and downward directions (the z-axis direction) and may include the at least one tray 400.

Each tray 400 may include space for accommodating/supporting a porter article and may stably carry the porter article.

The tray 400 may be a plate-shaped tray with a predetermined area parallel to a floor (the xy plane), and the porter robot 100 may position an article to be carried on the tray 400 and may move to the destination and may carry the article.

In this case, the tray 400 may include a slide module 240 for lifting the article to be carried up to the tray 400 above the traveling module 160. The slide module 240 may include a first slide 260 that moves forwards and backwards in a plane parallel to the ground surface (the xy plane) and operates to protrude outwards from the tray 400.

The slide module 240 may further include a second slide 270 above the first slide 260, which is disposed above the first slide 260 in a stationary state and operates to protrude outwards from the first slide 260 under the control of the control unit 140. The slide module 240 may further include wheels 290, which are disposed at opposite ends of ends, that is, the other ends of the second slide 270 and rotates with the traveling module 160 of the porter robot 100.

A width W1 of the second slide 270 may be smaller than a width W2 of the first slide 260.

The porter robot 100 may include a rack gear that is disposed below the first slide 260 in the x-axis direction and moves the first slide 260 forwards or backwards based on the x axis using power of a motor, and a pinion gear that is rotated using the power of the motor.

The porter robot 100 may include a rack gear that is disposed below the second slide 270 in the x-axis direction and moves the second slide 270 forwards or backwards based on the x axis using the power of the motor, and a pinion gear that is rotated using the power of the motor.

The slide module 240 may include a motor unit 280 that is disposed inside the tray 400 and controls an operation of the first slide 260 and the second slide 270.

The motor unit 280 may include first motors 281a and 282a configured to rotate a pinion gear disposed below the first slide 260.

With regard to the first motors 281a and 282a, the two motors 281a and 282a may be disposed at opposite edges of one end of the first slide 260, respectively, and may simultaneously rotate pinion gears on a lower surface of the first slide 260 to slide the first slide 260 forwards or backwards in the xy plane.

The motor unit 280 may further include second motors 281c disposed at opposite edges of the other end of the first slide 260.

The second motors 281c may include two motors at the edges of the other end of the first slide 260 and may rotate a pinion gear to move the second slide 270 forwards or backwards based on the x axis.

The motor unit 280 may further include third motors 281b, which are disposed at opposite edges of one end of the first slide 260, and may tilt the slide module 240 downwards from the tray 400 such that the slide module 240 forms an inclined surface.

The third motors 281b may be disposed at opposite edges of one end of the first slide 260 and may rotate a hinge 283 disposed at one end of the first slide 260 to tilt the first slide 260 downwards from the tray 400.

This inclined surface may be an inclined surface between the ground surface and the tray 400, and may be formed by tilting an end of the slide module 240, that is, the other end of the first slide 260 or the second slide 270, until the ground surface is reached, and when the end of the slide module 240 reaches the ground surface, the third motors may be stopped and the hinge 283 may be fixed.

As such, the porter robot 100 may control the motor unit 280 according to a control signal from the control unit 140, and thus may control the length of the slide module 240 and may control the inclination of the slide module 240 so as to carry a load or bag to be carried above the tray 400 along an inclination.

Hereinafter, an internal block for control of the porter robot 100 will be described.

FIG. 4 is a block diagram showing a control relationship in the mobile robot of FIG. 1.

Referring to FIG. 4, the porter robot 100 according to an embodiment of the present invention may include the control unit 140 for controlling the overall operation of the porter robot 100, a storage unit 130 for storing various data, and the communication unit 190 for transmitting and receiving data to and from other devices such as the server 2 or the like.

The control unit 140 may control the storage unit 130, the communication unit 190, a driving unit 160, the sensor unit 110, an output unit 180, and the like within the porter robot 100, and may control the overall operation of the porter robot 100.

The storage unit 130, which stores various kinds of information necessary to control the porter robot 100, may include a volatile or nonvolatile recording medium. Examples of the recording medium, which stores data readable by a microprocessor, may include a hard disk drive (HDD), a solid state disk (SSD), a silicon disk drive (SDD), a ROM, a RAM, a CD-ROM, a magnetic tape, a floppy disk, and an optical data storage device.

The communication unit 190 may include at least one communication module, through which the porter robot 100 may be connected to the Internet or to a predetermined network and may communicate with another device.

In addition, the communication unit 190 may be connected to a communication module provided in the server 2 in order to process transmission and reception of data between the porter robot 100 and the server 2.

The porter robot 100 according to the embodiment of the present invention may further include a speech input unit 125 for receiving user speech input through a microphone.

The speech input unit 125 may include or may be connected to a processing unit for converting analog sound into digital data such that a user speech input signal can be recognized by the control unit 140 or the server 2.

The storage unit 130 may store data for speech recognition, and the control unit 140 may process the user speech input signal received through the speech input unit 125, and may perform a speech recognition process.

The control unit 140 may perform control such that the robot 100 performs a predetermined operation based on the result of speech recognition.

The porter robot 100 may include the output unit 180 in order to display predetermined information in the form of an image or to output the predetermined information in the form of sound.

The output unit 180 may include a display 182 for displaying information corresponding to a command input by a user, the result of processing the command input by the user, the operation mode, the operation state, and an error state in the form of an image. In some embodiments, the porter robot 100 may include a plurality of displays 182.

In some embodiments, at least some of the displays 182 may be connected to a touchpad in a layered structure so as to constitute a touchscreen. In this case, the display 182 constituting the touchscreen may also be used as an input device for allowing a user to input information by touch, in addition to an output device.

In addition, the output unit 180 may further include a sound output unit 181 for outputting an audio signal. The sound output unit 181 may output an alarm sound, a notification message about the operation mode, the operation state, and the error state, information corresponding to a command input by a user, and a result of processing the command input by the user in the form of sound under the control of the control unit 140. The sound output unit 181 may convert an electrical signal from the control unit 140 into an audio signal, and may output the audio signal. To this end, a speaker or the like may be provided.

In some embodiments, the porter robot 100 may further include the image acquisition unit 120 for capturing an image of a predetermined range.

The image acquisition unit 120 may include a camera module for photographing the surroundings, an external environment, or the like of the porter robot 100. A plurality of cameras may be installed at predetermined positions for efficient capturing.

The image acquisition unit 120 may capture an image for user recognition or an image for a virtual fitting service. The control unit 140 may determine an external situation or may recognize a user (guidance target) based on the image captured by the image acquisition unit 120.

When the robot 100 is a porter robot, the control unit 140 may perform control such that the robot 100 travels based on the image captured by the image acquisition unit 120.

The image captured by the image acquisition unit 120 may be stored in the storage unit 130.

The porter robot 100 may further include the driving unit 160 (the traveling module in FIGS. 2 and 3) for movement, and the driving unit 160 may move the main body under the control of the control unit 140.

The driving unit 160 may include at least one driving wheel (not shown) for moving the main body of the robot 100. The driving unit 160 may include a driving motor (not shown) connected to the driving wheel for rotating the driving wheel. Driving wheels may be provided at left and right sides of the main body, and will hereinafter be referred to as a left wheel and a right wheel.

The left wheel and the right wheel may be driven by a single driving motor. If necessary, however, a left wheel driving motor for driving the left wheel and a right wheel driving motor for driving the right wheel may be individually provided. The direction in which the main body travels may be changed to the left or to the right based on the difference in the rotational speed between the left wheel and the right wheel.

The porter robot 100 may include the sensor unit 110 including sensors for sensing various kinds of data related to the operation and state of the porter robot 100.

The sensor unit 110 may further include an operation sensor for sensing the operation of the robot 100 and outputting operation information. For example, a gyro sensor, a wheel sensor, or an acceleration sensor may be used as the operation sensor.

The sensor unit 110 may include an obstacle sensor for sensing an obstacle. The obstacle sensor may include an infrared sensor, an ultrasonic sensor, an RF sensor, a geomagnetic sensor, a position sensitive device (PSD) sensor, a cliff sensor for sensing whether a cliff is present on a floor within a traveling area, and a light detection and ranging (LiDAR) unit.

The obstacle sensor senses an object, particularly an obstacle, present in the direction in which the mobile robot 100 travels (moves), and transmits information about the obstacle to the control unit 140. At this time, the control unit 140 may control the motion of the porter robot 100 depending on the position of the sensed obstacle.

The control unit 140 may perform control such that the operation state of the porter robot 100 or user input is transmitted to the server 2 through the communication unit 190.

When the porter robot 100 approaches a target position provided from a user, the control unit 140 may acquire an image of the surroundings from the image acquisition unit 120 at the corresponding position and may determine whether the user is present according to the image data.

In this case, when the user is present, the control unit 140 may read the size of a load, that is, an article to be carried and may control an operation of the slide module 240 depending on the size of the article.

The control unit 140 may perform an object recognition algorithm in order to determine the user and the size of the article from the image data.

Hereinafter, a porter control method of the porter robot 100 will be described in detail with reference to FIGS. 5 to 10.

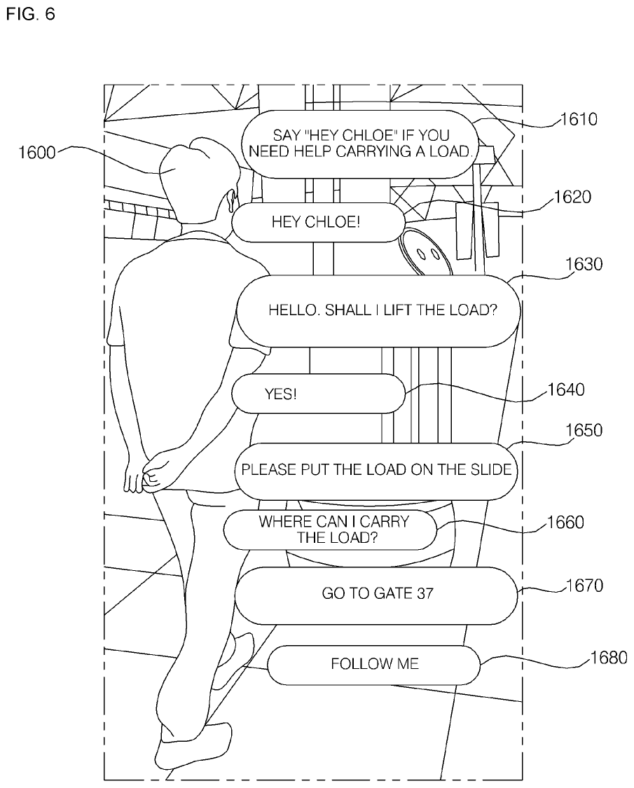

FIG. 5 is a flowchart showing a loading method of the mobile robot of FIG. 1. FIG. 6 is a diagram showing a state based on the loading method of FIG. 5.

Referring to FIG. 5, first, the porter robot 100 of the porter robot system may recognize a user from image data acquired through the camera (S10).

That is, the control unit 140 of the porter robot 100 may search for the user, and this user search may be performed by recognizing objects while continuously photographing the surroundings at a short distance through the image acquisition unit 120.

When the control unit 140 inputs a portion of the acquired image into a learning engine, the learning engine may recognize at least one object or living entity included in the input image. In more detail, the control unit 140 may analyze feature points from the recognized object to recognize a user, that is, the shape of the human of the living entity.

When the control unit 140 recognizes a person present at a short distance from a target position, the control unit 140 may perform matching while following the corresponding person through the head unit 180a. The control unit 140 may assume the corresponding person to be a user and may acquire movement of the user through the image acquisition unit 120 and the sensor unit 110 (S11).

The porter robot 100 may utter speech data indicating recognition of the user, and, for example, may utter ‘Say “Hey Chloe” if you need help carrying a load’ (1610).

In response thereto, when the user answers by saying ‘Hey Chloe’ (1620), the porter robot 100 makes an appropriate response to the answer, and for example, may again ask the user ‘Hello. Shall I lift the load?’ (1630). The control unit 140 of the porter robot 100 may detect a load or a bag of a user, which is positioned near the user, from the image acquisition unit 120, and may recognize the size of the bag (S12).

As such, whether the bag is present may be detected (S13), and in this case, the size of the bag may be recognized via input and extraction through a learning engine, as in user recognition.

In this case, when no bag is detected, the porter robot 100 may be moved in order to detect other users.

When a bag is detected, the size of the bag may be determined (S14).

When the bag is smaller than a lower size threshold value, the porter robot 100 may make an utterance corresponding thereto and may ask about information for a destination position.

In this case, an utterance such as ‘Please lift the load on the tray’ or the like may be made.

When the analyzed size of the bag is greater than the lower size threshold value, the porter robot 100 may make an utterance such as ‘Shall I lift the load?’ (1630) to the user (S15).

When a response from the user to the utterance of the porter robot 100 is acquired from the speech input unit 125, speech data about the response may be analyzed (S16).

When an expression in the response of the user is recognized to mean ‘Yes’ (S17), the slide module 240 may be stepwise driven according to the detected size of the bag.

That is, a plurality of motors of the motor unit 280 may be controlled to move the first slide 260 and the second slide 270 forwards and the third motors 281b may be driven to rotate and tilt the first slide 260 to extend the slide module 240 to the ground surface (S18).

When the slide module 240 reaches the ground surface, the control unit 140 may make an utterance such as ‘Please put the load on the slide’ or the like (1650), and may make an utterance asking about the carrying destination (1660).

Such an utterance may be ‘Where can I carry the load?’ or the like, and accordingly, when a spoken response is acquired from the user, destination information may be acquired from the user response and movement may be performed based thereon (1670).

In this case, the control unit 140 may make an utterance indicating the start of movement to the user, and in this case, the utterance may be ‘Please follow me’ or the like (1680).

The porter robot 100 may drive a plurality of motors of the slide module 240 according to the size of the bag and may drive the movement of a slide according to the size of the bag.

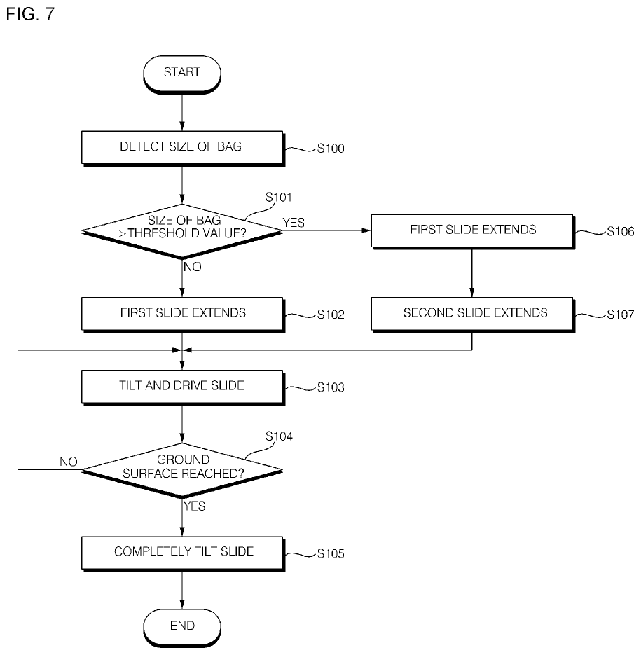

Hereinafter, control of the slide module 240 will be described with reference to FIGS. 7 to 10.

The control unit 140 may analyze image data from the image acquisition unit 120 and may detect the size of the bag (S100).

The control unit 140 may continuously receive a 2D image from the image acquisition unit 120, may extract the corresponding image as a 3D image of an outer appearance of the bag through modeling (a global geometry network), and may determine the size of the bag.

In this case, the recognized size of the bag may be compared with the lower size threshold value (S101).

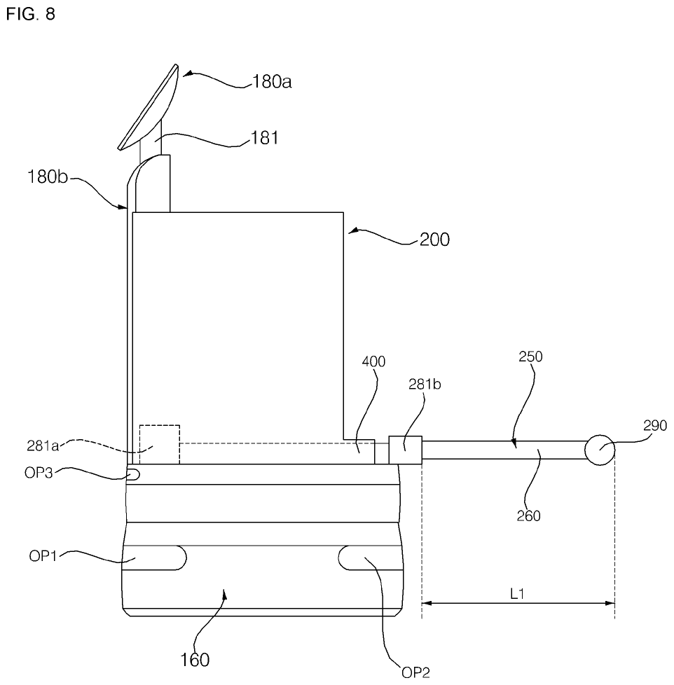

That is, when the size of the bag is not greater than the threshold value, as shown in FIG. 8, the first motor 281a may be driven to push the first slide 260 forwards such that the first slide 260 protrudes from the tray 400 (S102).

Then, the third motors 281b may be driven to tilt the first slide 260 until the other end of the first slide 260 reaches the ground surface (S103).

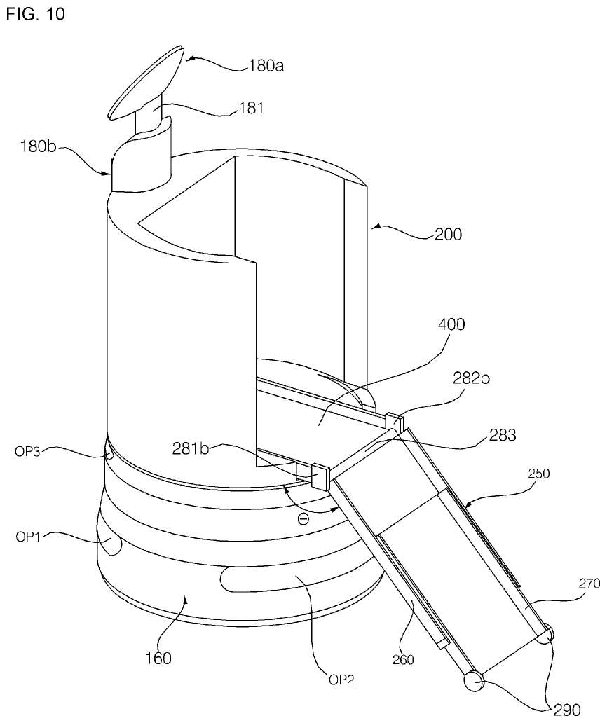

When the other end of the first slide 260 reaches the ground surface (S104), driving of the third motors 281b for tilting the slide module 240 may be stopped (S105), and as shown in FIG. 10, the first slide 260 may form an inclined surface for connection between the ground surface and the tray 400.

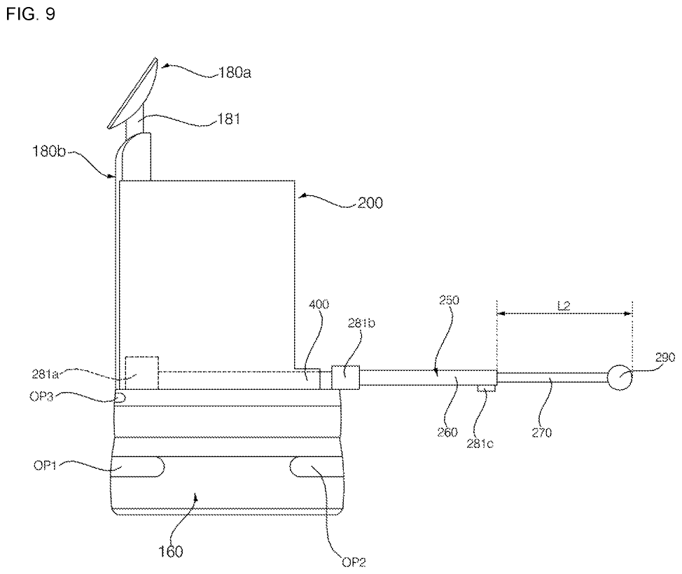

When the determined size of the bag is greater than the threshold value that defines the lower size, as shown in FIG. 8, the first slide 260 may be pushed forward to protrude from the tray 400 (S106). As shown in FIG. 9, the control unit 140 may drive the second motors 281c such that the second slide 270 protrudes forwards from the first slide 260 by a second length L2 according to the size of the bag, that is, the width of the bag (S107).

The second length L2 may extend until the width of the bag is smaller than the width of the inclined surface.

In this case, the width of the inclined surface may be equal to the sum of a first length L1, that is, the length of the first slide 260 and the second length L2, that is, the length that the second slide 270 protrudes.

As shown in FIG. 9, when the second slide 270 completely protrudes to the second length L2, the third motors 281b may be driven to tilt the first slide 260 (S103).

When the other end of the second slide 270 reaches the ground surface (S104), driving of the second motors 281c that makes inclination may be stopped to form a complexly inclined surface (S105).

As such, the size of the inclined surface may be controlled according to the size of the bag, and the inclined surface may be formed until the length of the controlled inclined surface is greater than the width of the bag.

Accordingly, when the bag is large, the user may carry the bag above the inclined surface using the inclined surface to easily move the bag up to the tray 400.

When the bag is accommodated in the tray 400, the porter robot 100 may carry the bag to the received destination to provide a safe and easy service to the user.

When carrying by the porter robot 100 is terminated, a return signal may be transmitted to the server 2, and the server 2, having received the return information, may update data based on the return information and may manage the data.

The system of the robot 100 according to the present invention and the method of controlling the same are not limitedly applied to the constructions and methods of the embodiments as previously described; rather, all or some of the embodiments may be selectively combined to achieve various modifications.

Meanwhile, the method of controlling the system of the robot 100 according to the embodiment of the present invention may be implemented as code that can be written on a processor-readable recording medium and thus read by a processor. The processor-readable recording medium may be any type of recording device in which data is stored in a processor-readable manner. The processor-readable recording medium may include, for example, read only memory (ROM), random access memory (RAM), compact disc read only memory (CD-ROM), magnetic tape, a floppy disk, and an optical data storage device, and may be implemented in the form of a carrier wave transmitted over the Internet. In addition, the processor-readable recording medium may be distributed over a plurality of computer systems connected to a network such that processor-readable code is written thereto and executed therefrom in a decentralized manner.

It will be apparent that, although the preferred embodiments have been shown and described above, the present invention is not limited to the above-described specific embodiments, and various modifications and variations can be made by those skilled in the art without departing from the gist of the appended claims. Thus, it is intended that the modifications and variations should not be understood independently of the technical spirit or prospect of the present invention.

### DESCRIPTION OF REFERENCE NUMERAL

| | |
|---|---|
| 100: porter robot | 2: server |
| 110: sensor unit | 120: image acquisition unit |
| 160: driving unit | 140: control unit |
| 190: communication unit | 250: slide module |

What is claimed:

1. A method of controlling a mobile robot, the method comprising:
receiving user input including a predetermined service request by the mobile robot;
determining a size of an article to be carried, by the mobile robot; and
forming an inclined surface by controlling a slide module disposed above a tray to move at least one slide of the slide module to protrude depending on the size of the article to be carried.

2. The method of claim 1, wherein the mobile robot is configured in such a way that the tray is defined as a plat surface that accommodates the article to be carried and that the slide module is disposed above the tray and includes the at least one slide moved to protrude in a direction parallel to the tray.

3. The method of claim 2, wherein the forming the inclined surface includes disposing the slide module above the tray and moving the at least one slide to protrude in the direction parallel to the tray.

4. The method of claim 3, wherein the forming the inclined surface includes forming the inclined surface by controlling a motor of the slide module to tilt the at least one slide that protrudes.

5. The method of claim 3, wherein, when a size of the article to be carried is equal to or greater than a predetermined size, the inclined surface is formed by moving a first slide to protrude and then moving a second slide disposed above the first slide to protrude from the first slide.

6. The method of claim 5, wherein movement of the second slide is controlled to satisfy a condition in which the sum of a length of the first slide and a length that the second slide protrudes is greater than a width of the article to be carried.

7. The method of claim 1, wherein the determining the size of the article to be carried includes acquiring an image from an image sensor and extracting a size of the article to be carried by learning an object.

8. The method of claim 1, wherein the receiving the user input includes:
asking about whether the article is carried;
receiving a response of the user in response to the asking; and
analyzing whether a user request is present, from the response of the user.

9. The method of claim 1, further comprising searching for the user at a short distance, following the retrieved user, and acquiring an image of the user, by the mobile robot.

10. A mobile robot comprising:
a body forming an outer appearance;
a driving part configured to move the body;
an image sensor configured to capture an image of a traveling area and to generate image information;
a tray configured to support an article to be carried; and
a controller configured to determine a size of the article to be carried and to form an inclined surface by controlling a slide module disposed above the tray to move at least one slide of the slide module to protrude depending on the size of the article to be carried.

11. The mobile robot of claim 10, wherein the mobile robot is configured in such a way that the slide module is disposed above the tray and includes the at least one slide moved to protrude in a direction parallel to the tray.

12. The mobile robot of claim 11, wherein the slide module is disposed above the tray and moves the at least one slide to protrude in the direction parallel to the tray.

13. The mobile robot of claim 12, wherein the inclined surface is formed by controlling a motor of the slide module to tilt the at least one slide that protrudes.

14. The mobile robot of claim 12, wherein, when a size of the article to be carried is equal to or greater than a predetermined size, the inclined surface is formed by moving a first slide to protrude and then moving a second slide disposed above the first slide to protrude from the first slide.

15. The mobile robot of claim 14, wherein movement of the second slide is controlled to satisfy a condition in which the sum of a length of the first slide and a length that the second slide protrudes is greater than a width of the article to be carried.

16. The mobile robot of claim 11, wherein the controller acquires an image from the image sensor and extracts a size of the article to be carried by learning an object.

17. The mobile robot of claim 11, wherein the controller asks about whether the article is carried and analyzes whether a user request is present, from the response of the user to the asking.

18. The mobile robot of claim 11, wherein the mobile robot searches for the user at a short distance, follows the retrieved user, and acquires an image of the user.

19. The mobile robot of claim 18, wherein the mobile robot transmits information indicating that carrying is terminated, to a server, and returns to a start point.
